(19) United States
(12) Patent Application Publication
(10) Pub. No.: US 2025/0306785 A1
(43) Pub. Date: Oct. 2, 2025

(54) ACCURATE CAPACITY ADJUSTMENT FACTOR

(71) Applicant: Micron Technology, Inc., Boise, ID (US)

(72) Inventor: Christian M. Gyllenskog, Meridian, ID (US)

(21) Appl. No.: 19/082,000

(22) Filed: Mar. 17, 2025

Related U.S. Application Data
(60) Provisional application No. 63/570,703, filed on Mar. 27, 2024.

(51) Int. Cl. G06F 3/06

(52) U.S. Cl. CPC G06F 3/0631; G06F 3/0604; G06F 3/0683

(57) ABSTRACT

Methods, systems, and devices for accurate capacity adjustment factor are described. A request for a memory system to signal a capacity of the memory system may be received. Based on the request, a message indicating a capacity of a section of memory in the memory system that includes multiple-level cells may be transmitted to the host system. The message may include a first indication of a potential capacity of the multiple-level cells and a second indication of a configured capacity of the multiple-level cells.

### CROSS REFERENCE

The present application for patent claims priority to U.S. Patent Application No. 63/570,703 by Gyllenskog, entitled “ACCURATE CAPACITY ADJUSTMENT FACTOR,” filed Mar. 27, 2024, which is assigned to the assignee hereof, and which is expressly incorporated by reference in its entirety herein.

### TECHNICAL FIELD

The following relates to one or more systems for memory, including an accurate capacity adjustment factor.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports using an accurate capacity adjustment factor in accordance with examples as disclosed herein.

FIG. 2 shows an example of a set of operations for an accurate capacity adjustment factor in accordance with examples as disclosed herein.

FIG. 3 shows an example of a message format that supports using an accurate capacity adjustment factor in accordance with examples as disclosed herein.

FIG. 4 shows a block diagram of a memory system that supports using an accurate capacity adjustment factor in accordance with examples as disclosed herein.

FIG. 5 shows a block diagram of a host system that supports using an accurate capacity adjustment factor in accordance with examples as disclosed herein.

FIGS. 6 through 8 show flowcharts illustrating a method or methods that support using an accurate capacity adjustment factor in accordance with examples as disclosed herein.

### DETAILED DESCRIPTION

A section of memory may include multiple-level cells (e.g., bi-level cells capable of storing two bits of information, tri-level cells capable of storing three bits of information, quad-level cells capable of storing four bits of information, and so on). A capacity adjustment factor may be used to indicate (e.g., to a host system) the available capacity of a section of memory. In some examples, the available capacity of a section of memory may differ from the potential capacity of the section of memory—e.g., if the section of memory includes multiple-level cells, such as quad-level cells, and is configured to be programmed to store fewer bits, such as using tri-level programming techniques.

Techniques for determining and indicating a capacity adjustment factor for a section of memory may lack accuracy (e.g., based on using a 256 basis for a fractional component). In some examples, the inaccuracy in the capacity adjustment factor may cause a host device to determine an available capacity for a section of memory that is different than the actual available capacity of the section of memory, which may result in underutilization of the section of memory. Thus, mechanisms (e.g., methods, systems, apparatuses, techniques, configurations, components) that support more accurate representation of the capacity adjustment factor may be desired. Additionally, techniques for determining and indicating capacity adjustment factors with more accuracy while maintaining backwards-compatibility with existing systems, such as host systems, may be desired.

To support, with reduced complexity (e.g., relative to other options for signaling accurate capacity adjustment factors that introduce new parameters), the accurate representation of capacity adjustment factors while maintaining support for existing systems, a first field of a parameter for indicating a capacity adjustment factor may indicate a numerator (and, in some examples, fractional numerators) of the capacity adjustment factor and a second field of the parameter for indicating the capacity adjustment factor may indicate a denominator (and, in some examples, fractional denominators) of the capacity adjustment factor. In some examples, to maintain support for existing systems, the numerator may be one-based and the denominator may be zero-based. In other examples, to maintain support for existing systems, a new field that is supported by a first one or more host systems (but not a second one or more host systems) may be used to indicate to the first one or more host systems whether the numerator/denominator technique, or a different technique, is being used by a memory system to indicate the capacity adjustment factor.

In addition to applicability in memory systems as described herein, techniques for accurately conveying a capacity adjustment factor may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving an accuracy with which a capacity adjustment factor may be indicated, which may enable full utilization of the capacity of a memory system, among other benefits.

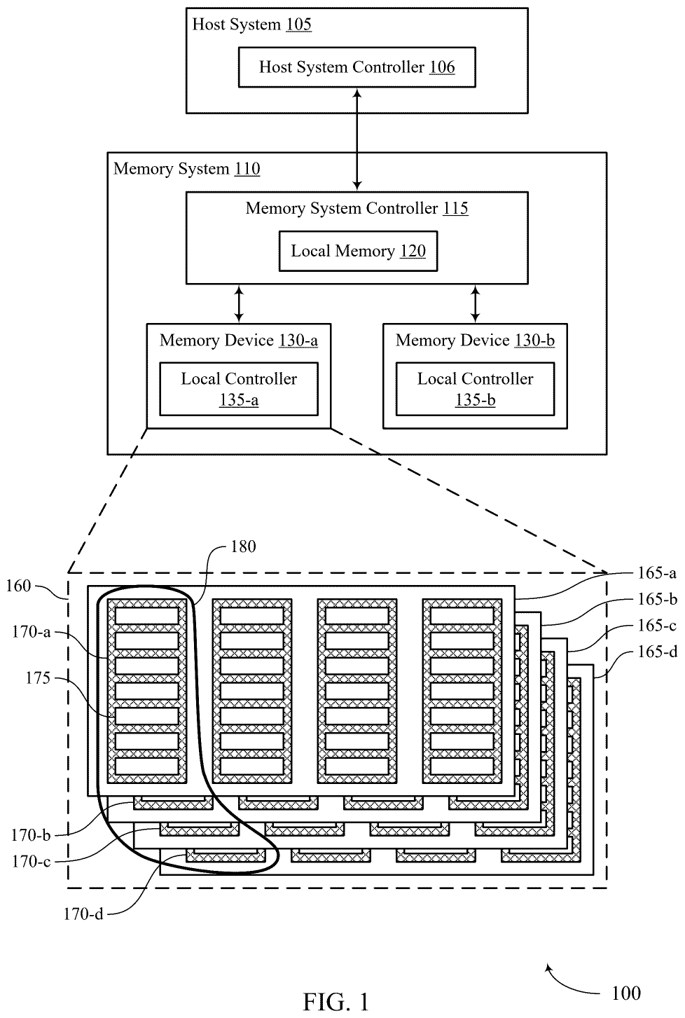

FIG. 1 shows an example of a system 100 that supports an accurate capacity adjustment factor in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random-access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support accurate capacity adjustment factor. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

A memory system may include one or more X-level cells—e.g., single-level cells, bi-level cells (which may also be referred to as multi-level cells), tri-level cells, quad-level cells, and so on. Single-level cells may be capable of storing one (1) bit of data (corresponding to two (2) logic states), bi-level cells may be capable of storing two (2) bits of data (corresponding to four (4) logic states), tri-level cells may be capable of storing three (3) bits of data (corresponding to eight (8) logic states), quad-level cells may be capable of storing (4) bits of data (corresponding to sixteen (16) logic states), and so on. In some examples, an X-level cell may be operated in lower-level modes. For example, a quad-level cell may be operated in a single-level mode (and used to store one bit of data), a bi-level mode (and used to store two bits of data), or a tri-level mode (and used to store three bits of data). In some examples, a lower-level programming operation may be completed for a higher-level cell in less time, with more reliability, or both, than a higher-level programming operation for the higher-level cell. In some examples, an X-level cell may be a fractional-level cell (e.g., a 3.8-level cell capable of indicating 3.8 bits of data), where fractional-level cells may be programmed using fractional level programming techniques.

In some examples, a memory system that includes a set of higher-level cells may allocate (e.g., pre-deployment) one or more sections of the set of higher-level cells to be accessed (e.g., by a host system) using respective lower-level programming techniques. In some examples, the one or more sections of memory may be referred to as logical units. For example, a memory system that includes a set of quad-level cells may allocate a first section of the quad-level cells to be accessed using single-level techniques and a second section of the quad-level cells to be accessed using tri-level techniques. In such cases, a capacity of the memory system may be reduced relative to if only quad-level techniques were used to access the quad-level cells. For example, if the set of quad-level cells is capable of storing one (1) terabyte of data but the memory system allocates 10% of the quad-level cells to be accessed using single-level programming techniques and another 10% of the quad-level cells to be accessed using tri-level programming techniques, then the set of quad-level cells may instead be capable of storing 900 gigabytes of data—

$$( ( 1 terabyte * \frac{8}{10} ) + ( 100 gigabytes * \frac{1}{4} ) + ( 100 gigabytes * \frac{3}{4} ) )$$

—where the first 10% of the quad-level cells may be configured to store 25 gigabytes of data using the single-level techniques and the second 10% of the quad-level cells may be configured to store 75 gigabytes of data using the tri-level techniques. In some examples, the different combinations of higher-level memory cells and lower-level programming techniques may be referred to as enhanced memory types—e.g., single-level on QLC, tri-level on QLC, bi-level on TLC).

In some examples, the capacity of a memory system may be provided in allocation units. For example, for one (1) kilobyte allocation units, a one (1) terabyte memory system including quad-level cells may be identified as having 1e9 allocation units. In some examples, the quantity of allocation units available may change based on whether one or more sections of the memory are configured for enhanced memory operations. For example, if the memory system allocates 10% of the quad-level cells to be accessed using single-level programming techniques, then rather than 1e8 allocation units being allocated to the section of memory, 2.5e7 allocation units may be identified as being allocated to the section of memory (because less data is capable of being written to the section of memory than if the section of memory were access using quad-level programming techniques). In such cases, the memory system may be identified as having 9.25e8 total allocation units.

Accordingly, techniques may be used that enable a memory system to indicate, to a manufacturer of a host system, an actual capacity of the memory system after allocation of section of the memory cells to particular memory types. These techniques may also be used by a host system to keep track of the actual capacity of a memory system during post-deployment operation. In some examples, these techniques may include storing, at the memory system, an indication of the memory types of different sections of the X-level cells in a memory system along with other parameters for the memory system. Information related to the partitioning of a memory system, memory types of particular sections of memory, allocation unit sizes, segment sizes, and the like may be referred to as a geometry of the memory system.

In some examples, a memory system may indicate when one or more sections of higher-level cells are configured to operate in one or more lower-level modes—e.g., by setting and, in some examples, indicating a capacity adjustment factor, CapAdjFactor, to a host system. In some examples, a size of the system code capacity adjustment factor may be represented using one byte. The capacity adjustment factor may indicate a potential capacity of a section of the memory system relative to a configured capacity of the section of the memory system. The capacity adjustment factor may indicate, for a section of the memory system (which may be referred to as a memory type) configured with higher-level cells, a ratio between a first capacity of the section of the memory system obtained were a X-level programming technique configured to be used for corresponding X-level cells in the section (which may be referred to as Capacity_{NormalMem}) and a second capacity of the section of the memory system obtained when a lower-level programming technique is configured to be used for X-level cells (which may be referred to as Capacity_{section})—i.e.,

$$CapAdjFactor = \frac{{Capacity}_{NormalMem}}{{Capacity}_{Section}} .$$

For example, for a section of a memory system (e.g., corresponding to a first memory type in a memory system) configured with quad-level cells that are operated in a single-level mode, the capacity adjustment factor may indicate that the available capacity of the section of the memory system is four (4) times as small (and may be represented as hex: 04h; bin: 0000 0100) as the capacity of the section of the memory system being utilized. For a section of the memory system configured with quad-level cells that are operated in a bi-level mode (e.g., corresponding to a second memory type in a memory system), the capacity adjustment factor may indicate that the available capacity of the section of the memory system is two (2) times as small (and may be represented as hex: 02h; bin: 0000 0010) as the capacity of the section of the memory system being utilized. For a section of the memory system configured with quad-level cells that are operated in a quad-level mode, the capacity adjustment factor may indicate that the available capacity of the section of the memory system is one (1) times as small (and may be represented as hex: 01h; bin: 0000 0001)—i.e., the same—as the capacity of the section of the memory system being utilized.

For a section of the memory system configured with tri-level cells that are operated in a single-level mode, the capacity adjustment factor may indicate that the available capacity of the section of the memory system is three (3) times as small (and may be represented as hex: 03; bin: 0000 0011) as the capacity of the section of the memory system being utilized, and so on. For a section of the memory system configured with bi-level cells that are operated in a single-level mode, the capacity adjustment factor may indicate that the available capacity of the section of the memory system is two (2) times as small (and may be represented as hex: 02; bin: 0000 0010) as is being utilized, and so on. For a section of the memory system configured with single-level cells that are operated in a single-level mode, the capacity adjustment factor may indicate that the available capacity of the section of the memory system is one (1) times as small (and may be represented as hex: 01; bin: 0000 0001)—i.e., the same—as the capacity of the section of the memory system being utilized.

In some examples, the memory system may indicate the capacity adjustment factor for a section of memory allocated for the storage of system code, wSystemCodeCapAdjFac, which may be derived by calculating the following equation: wSystemCodeCapAdjFac=INT(256*CapAdjFactor). In some examples, a size of the system code capacity adjustment factor may be two bytes. Multiplying the capacity adjustment factor by 256 may shift the capacity adjustment factor into the leftmost byte of the two bytes. For example, for the section of the memory system configured with quad-level cells that are operated in the single-level mode, the system code capacity adjustment factor may be represented as hex: 0400; bin: 0000 0100 0000 0000. For the section of the memory system configured with quad-level cells that are operated in the bi-level mode, the system code capacity adjustment factor may be represented as hex: 0200; bin: 0000 0010 0000 0000. For the section of the memory system configured with quad-level cells that are operated in the quad-level mode, the system code capacity adjustment factor may be represented as hex: 0100; bin: 0000 0001 0000 0000. For the section of the memory system configured with tri-level cells that are operated in the single-level mode, the system code capacity adjustment factor may be represented as hex: 0300; bin: 0000 0011 0000 0000, and so on. For the section of the memory system configured with bi-level cells that are operated in the single-level mode, the system code capacity adjustment factor may be represented as hex: 0200; bin: 0000 0010 0000 0000, and so on. For the section of the memory system configured with single-level cells that are operated in the single-level mode, the system code capacity adjustment factor may be represented as hex: 0100; bin: 0000 0001 0000 0000, and so on.

Shifting the system code capacity adjustment factor may enable fractional (system code) capacity adjustment factors to be indicated to a host system, where the leftmost byte may represent a whole number component of the system code capacity adjustment factor and the rightmost byte may represent a fractional number component of the system code capacity adjustment factor (using a 256 basis). For example, for a section of the memory system configured with tri-level cells that are operated in a bi-level mode, the system code capacity adjustment factor may be represented as hex: 0180; bin: 0000 0001 1000 0000—where the leftmost byte may represent the whole number component as 1 and the rightmost byte may represent the fraction number component as 128/256 (i.e., 0.5) to together represent a system code capacity adjustment factor of 1.5.

In some examples, the system code capacity adjustment factor (e.g., along with additional capacity adjustment factors for other memory sections) is indicated in a Universal Flash Storage (UFS) Protocol Information Unit (UPIU) that describes geometric parameters of the memory system (which may be referred to as a Geometry Descriptor UPIU). In some cases, a location of the system code capacity adjustment factor may be offset from a beginning of the UPIU by a certain amount—e.g., the system code capacity adjustment factor may be located at a 24h offset (where the offsets may be indicated on a hex-basis. Also, if a size of the system code capacity adjustment factor is two bytes, the system code capacity adjustment factor may begin at the 24h offset and span the adjacent 25h offset—e.g., such that a next parameter indicated in the UPIU may begin at the 26h offset.

As indicated above, the system code capacity adjustment factor, wSystemCodeCapAdjFac, may be derived by calculating the following equation:

$$wSystemCodeCapAdjFac = INT ( 256 * \frac{{Capacity}_{NormalMem}}{{Capacity}_{SystemCode}} ) .$$

However, the 256-basis used for the fractional component of the system code capacity adjustment factor may not accurately represent all of the possible system code capacity adjustment factors. For example, if a section of quad-level cells is programmed with a tri-level programming technique, then the CapAdjFactor ratio may be equal to 1.33333, and the system code capacity adjustment factor may be determined to be hex: 0155; bin: 0000 0001 0101 0101. Thus, the leftmost byte may represent the whole number component as one (1) and the rightmost byte may represent the fraction number component as 85/256 (i.e., 0.33203) to together represent a system code capacity adjustment factor of 1.33203. Accordingly, the represented system code capacity adjustment factor for this memory type may differ from the actual system code capacity adjustment factor by 0.00130. This approximation of the actual capacity of a memory system may be larger or smaller for other non-256 based fractional system code capacity adjustment factor. Also, the difference between the capacity indicated to a host system for a section of memory that uses a lower-level programming technique and the actual capacity of the section of memory resulting from indicating inaccurate fractional capacity adjustments may increase as the total capacity of memory systems continue to increase.

Thus, mechanisms (e.g., methods, systems, apparatuses, techniques, configurations, components) that support more accurate representation of capacity adjustment factors for memory sections (e.g., a system code memory section) may be desired.

One option for supporting the accurate representation of the capacity adjustment factor is to introduce an additional parameter CapAdjFacMod that supplements the wSystemCodeCapAdjFac parameter and can be used, together with the wSystemCodeCapAdjFac parameter, to indicate accurate fractional capacity adjustment factors. In some examples, the CapAdjFacMod may be included in the UPIU that describes geometric parameters of the memory system. In some examples, a size of CapAdjFacMod parameter may be one-byte, two-bytes, etc.

For example, to accurately support fractional capacity adjustment factors, the wSystemCodeCapAdjFac parameter may be calculated using the following equation:

$$wSystemCodeCapAdjFac = CapAdjFacMod * \frac{{Capacity}_{NormalMem}}{{Capacity}_{SystemCode}} ,$$

where
CapAdjFacMod=Capacity_{NormalMem}−1. In such cases, both the two-byte wSystemCodeCapAdjFac parameter and the one-byte CapAdjFacMod parameter may be indicated to a host system and may be used together to determine an accurate capacity adjustment factor. For example, if a quad-level cell is programmed with a single-level programming technique, then the wSystemCodeCapAdjFac parameter may be equal to

$$( 4 - 1 ) * \frac{4}{1} ,$$

which may be equivalent to 12 (and may be represented as hex: 0C00; bin: 0000 1100 0000 0000). If a quad-level cell is programmed with a bi-level programming technique, then the wSystemCodeCapAdjFac parameter may be equal to

$$( 4 - 1 ) * \frac{4}{2} ,$$

which may be equivalent to 6 (and may be represented as hex: 0600; bin: 0000 0110 0000 0000). If a quad-level cell is programmed with a tri-level programming technique, then the wSystemCodeCapAdjFac parameter may be equal to

$$( 4 - 1 ) * \frac{4}{3} ,$$

Which may be equivalent to 4 (and may be represented as hex: 0040; bin: 0000 0100 0000 0000). And if a quad-level cell is programmed with a single-level programming technique, then the wSystemCodeCapAdjFac parameter may be equal to

$$( 4 - 1 ) * \frac{4}{4} ,$$

which may be equivalent to 3 (and may be represented as hex: 0300; bin: 0000 0011 0000 0000).

Then, the separately indicated CapAdjFacMod parameter may be used to determine an accurate capacity adjustment factor—e.g., by dividing the wSystemCodeCapAdjFac parameter by the CapAdjFacMod parameter. For example, for a quad-level cell programmed with a single-level programming technique, the wSystemCodeCapAdjFac parameter may be equivalent to twelve (12), the CapAdjFacMod may be equivalent to 3, and the accurate capacity adjustment factor may be determined to be 4. For a quad-level cell programmed with a bi-level programming technique, the wSystemCodeCapAdjFac parameter may be equivalent to six (6), the CapAdjFacMod may be equivalent to 3, and the accurate capacity adjustment factor may be determined to be 2. For a quad-level cell programmed with a tri-level programming technique, the wSystemCodeCapAdjFac parameter may be equivalent to four (4), the CapAdjFacMod may be equivalent to 3, and the accurate capacity adjustment factor may be determined to be 4/3 (i.e., 1.33333). And, for a quad-level cell programmed with a quad-level programming technique, the wSystemCodeCapAdjFac parameter may be equivalent to three (3), the accurate capacity adjustment factor may be equivalent to three (3), and the CapAdjFactor ratio may be determined to be one (1).

But changing the calculation for obtaining the wSystemCodeCapAdjFac parameter to represent a multiple of the capacity adjustment factor and introducing a new complementary parameter that, together with the modified wSystemCodeCapAdjFac parameter, supports accurately indicating fractional capacity adjustment ratios may cause incompatibilities with existing host systems—e.g., as existing host systems that reads the wSystemCodeCapAdjFac parameter may overestimate the capacity adjustment factor, by the corresponding multiple. Additionally, though such a change may work for lower-level cells (e.g., quad-level and lower), the ability to accurately indicate capacity adjustment factors may degrade as higher-level cells are implemented—e.g., for a five-level cell, this scheme may inaccurately represent the wSystemCodeCapAdjFac parameter when a tri-level programming technique is used. Thus, mechanisms (e.g., methods, systems, apparatuses, techniques, configurations, components) that support, with reduced complexity, the accurate representation of capacity adjustment factors for additional (e.g., all) combinations of X-level cell and Y-level programming techniques (including fractional-level cells and fractional-level programming techniques) while maintaining support for existing devices may be desired.

To support, with reduced complexity, the accurate representation of capacity adjustment factors for additional combinations of X-level cell and Y-level programming techniques while maintaining support for existing systems, a first field of a parameter for indicating a capacity adjustment factor may indicate a numerator (and, in some examples, a fractional numerator) of the capacity adjustment factor and a second field of the parameter for indicating the capacity adjustment factor may indicate a denominator (and, in some examples, a fractional denominator) of the capacity adjustment factor. In some examples, to maintain support for existing devices, the numerator may be one-based and the denominator may be zero-based. In other examples, to maintain support for existing devices, a new field that is supported by a first set of host systems (but not a second set of host systems) may be used to indicate to the first set of host systems whether the numerator/denominator technique, or a different technique, is being used by a memory system to indicate the capacity adjustment factor.

In some examples, a memory system (e.g., that includes multiple-level memory cells) may receive, from a host system, a request for a capacity of the memory system. Based on receiving the request, the memory system may transmit a message indicating a capacity of one or more sections of memory—e.g., based on a programming mode (e.g., SLC on TLC, TLC on QLC) configured for the one or more sections of memory. For example, for a first section of memory, the message may include a first indication (e.g., in a first field, at a first offset, or both) of a potential capacity of multiple-level cells (as “the numerator”) in the first section of memory. In some examples, if the multiple-level cells are QLCs, the first indication may indicate a potential capacity of the multiple-level cells as four (4), or a multiple of four. The message may also include a second indication (e.g., in a second field, at a second offset, or both) of a configured capacity of the plurality of multiple-level cells (as “the denominator”) in the first section of memory. In some examples, if the first section of memory is configured to be accessed using a lower-level programming mode (e.g., a TLC programming mode), the second indication may indicate a configured capacity of the multiple-level cells as three (3), or a multiple of three.

In some examples, to maintain compatibility with existing host systems that are configured to determine a capacity adjustment factor for a section of memory by obtaining a whole number component from a first field of the message and a fractional number component from a second field of the message, the memory system may signal in a new field that is known to a subset of the host system whether the numerator/denominator technique or the whole number component/fractional number component technique is being used.

By explicitly indicating the potential capacity and the configured capacity, a capacity adjustment factor may be accurately indicated for a section of memory. Moreover, by retaining support for existing devices that use the whole number component/fractional number component technique, memory systems may be compatible with an increased quantity of host systems.

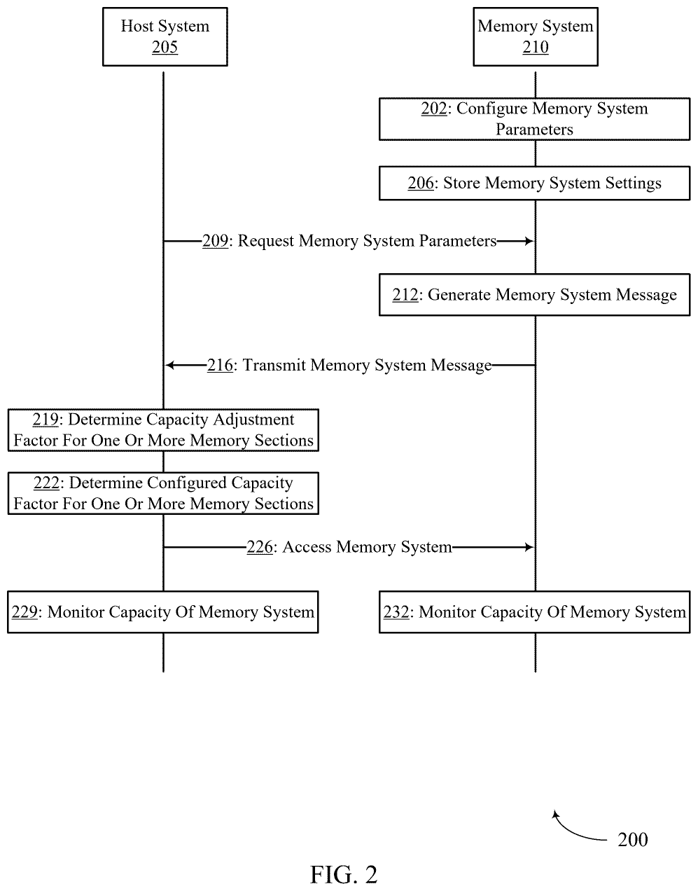

FIG. 2 shows an example of a set of operations for an accurate capacity adjustment factor in accordance with examples as disclosed herein.

The process flow 200 may be performed by the host system 205 and the memory system 210, which may be respective examples of a host system described herein (e.g., the host system 105 of FIG. 1) and a memory system described herein (e.g., the memory system 110 of FIG. 1). In some examples, the process flow 200 shows an example set of operations performed to support an accurate capacity adjustment factor. For example, the process flow 200 may include operations for signaling a capacity of a memory system in accordance with capacity adjustment factors for one or more sections of memory.

At 202, one or more parameters of the memory system 210 may be configured. In some examples, the parameters may include “geometric” parameters of the memory system 210, such as a partitioning of the memory into sections, a location of the sections of memory within the memory, a capacity of the sections of memory, allocation unit sizes, and the like. In some examples, the memory system 210 may be configured with a section of memory (which may be referred to as a system code memory section) that is allocated for the storage of system code for the host system 205. Additionally, or alternatively, the memory system 210 may be configured with a section of memory (which may be referred to as an enhanced memory section) that is allocated for, for example, the low latency storage data for the host system 205. In some examples, the memory system 210 may be configured with one or more (e.g., multiple) enhanced memory sections.

As described herein, the memory system 210 may include multiple-level cells (e.g., MLCs, TLCs, QLCs). In such cases, a system code memory section may include a first set of the multiple-level cells and any enhanced memory section(s) may include second set(s) of the multiple-level cells. In some examples, (e.g., to improve reliability of data storage in a memory section, to reduce latency for storing data in a memory section), a lower-level programming mode may be configured for a particular memory section, and the memory system 210 may limit access to the memory section in accordance with the configured programming mode. For example, to increase reliability for the storage of system code, the system code memory section may be configured to be accessed (and thus accessed during operation) with a TLC programming mode. In another example, to reduce a latency for storing data in the memory system, a first enhanced memory section may be configured to be accessed (and thus accessed during operation) with an SLC programming mode—in such cases, the data in the enhanced memory section may later be transferred to (which may also be referred to as folded into) another memory section, for example, that includes QLCs.

In some examples, in addition to configuring one or more memory sections for enhanced memory operations (such as TLC on QLC), the memory system 210 may be configured to indicate capacity adjustment factors for the one or more memory sections in accordance with a first technique (e.g., an accurate numerator/denominator technique) or a second technique (e.g., a less-accurate whole number/fractional number technique).

As described herein, configuring sections of memory with lower-level programming modes (than would be supported by the multiple-level cells) may reduce an actual capacity of the memory system 210 relative to if only the corresponding-level programming mode were used. Accordingly, to prevent the host system 205 from over-utilizing the memory system 210, the host system 205 may identify the actual capacity of the memory system 210 in accordance with the parameters configured for the memory system 210.

At 206, the memory system settings configured for the memory system 210 (e.g., in accordance with the configured memory system parameters) may be stored (e.g., in non-volatile memory) at the memory system 210. For example, the memory system 210 may store a first indication of the potential capacity of the system code memory section and a second indication of the configured capacity of the system code memory section—e.g., if the system code memory section includes QLCs and is configured for TLC programming, then the memory system 210 may store a first value (e.g., the number four (4)) indicating the potential capacity of the system code memory section and a second value indicating the configured capacity of the system code memory section (e.g., the number three (3)). In some examples, the memory system 210 may further store a capacity adjustment factor for the system code memory section calculated based on the potential capacity of the system code memory section and the configured capacity of the system code memory section—e.g., by calculating

$$INTEGER ( 256 \times \frac{pot . capacity}{conf . capacity} ) .$$

The memory system 210 may similarly store the potential capacity, configured capacity, and capacity adjustment factor for one or more enhanced memory sections. The memory system 210 may also store an indication of whether the memory system 210 is configured to indicate capacity adjustment factors using the first technique (e.g., the accurate numerator/denominator technique) or the second technique (e.g., the less-accurate whole number/fractional number technique).

At 209, memory system parameters may be requested from the memory system 210 (e.g., when the host system 205 initially connects with the memory system 210, at power-on). In some examples, to request the memory system parameters, the host system 205 transmits a query request UPIU that addresses a Geometry Descriptor message for the memory system 210 (e.g., by setting a descriptor ID to a corresponding value).

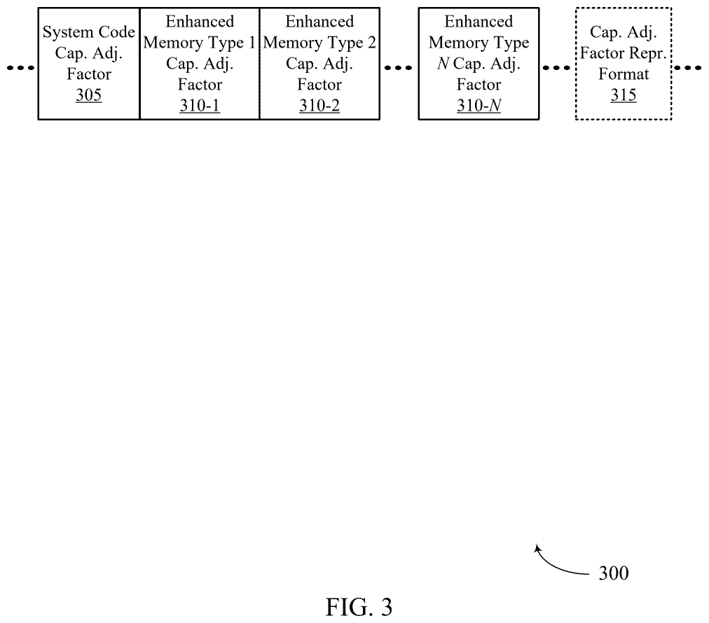

At 212, a memory system message (e.g., a Geometry Descriptor UPIU) may be generated in response to the request for the memory system parameters—e.g., in accordance with the memory system settings stored at the memory system 210. The memory system message may include one or more indications of capacity adjustment factors for one or more memory sections. The memory system message may also include an indication of whether the first technique (e.g., the accurate numerator/denominator technique) or the second technique (e.g., the less-accurate whole number/fractional number technique) for indicating the capacity adjustment factor is configured for the memory system 210. The memory system message is described in more detail herein, including with reference to FIG. 3.

At 216, the generated memory system message may be transmitted to the host system 205. The memory system may include the geometric information for the memory system 210 that is stored at the memory system 210.

At 219, a capacity adjustment factor for one or more memory sections configured for the memory system 210 may be determined based on reading the memory system message. For example, a capacity adjustment factor may be determined for a system code memory section, a non-persistent memory section, any enhanced memory type sections, or any combination thereof.

At 222, a configured capacity (as opposed to a potential capacity) of the memory system 210 may be determined. In some examples, the configured capacity is determined on a per-memory section basis—e.g., a capacity of a system code memory section, a non-persistent memory section, and/or any enhanced memory type sections may be identified. In some examples, determining the configured capacity of the memory system 210 involves determining a quantity of allocation units supported by the memory system 210. In some examples, the allocation units are determined on a per-memory section basis. The capacity of (and/or allocation units allocated to) a memory section may be determined in accordance with capacity adjustment factors determined for respective memory sections.

In some examples, the number of allocation units, dNumAllocUnits, allocated to a section of memory (which may also be referred to as a logical unit) may be determined by calculating, for each logical unit:

$$CEILING ( \frac{LUCapacity * CapAdjFactor}{bAllocationUnitSize * dSegmentSize * 512} )$$

when the less-accurate whole number/fractional number technique is used (e.g., when bCapAdjFacRepresentation is equal to 0h). The parameter bAllocationUnitSize may indicate a size of allocation units (and may be expressed as a quantity of segments) and dSegmentSize may indicate a size of a segments (and may be expressed in 512-byte units). For example, if the segment size is configured to be 1024 bytes, and an allocation unit size is allocated to be 8 segments, then the number of allocation units allocated to a 4 GByte system code memory section that is configured for TLC on QLC operations may be determined as

$$CEILING ( \frac{4 * 1.332 GBytes}{8 * 2 * 512 bytes} ) ,$$

may reduce to

$$CEILING ( \frac{5328000 KBytes}{8.1 \; 92 Kbytes} ) ,$$

which is equal to 650,391 allocation units.

In other examples, the number of allocation units, dNumAllocUnits, allocated to a section of memory may be determined by calculating, for each logical unit:

$$CEILING ( \frac{LUCapacity * MSByte ( CapAdjFactor )}{\begin{matrix}bAllocationUnitSize * dSegmentSize * \\ 512 * LSByte ( CapAdjFactor )\end{matrix}} )$$

when the numerator/denominator technique is used (e.g., when bCapAdjFacRepresentation not equal to 0h). For example, if the segment size is configured to be 1024 bytes, and an allocation unit size is allocated to be 8 segments, then the number of allocation units allocated to a 4 GByte system code memory section that is configured for TLC on QLC operations may be determined as

$$CEILING ( \frac{4 * 4 GBytes}{8 * 2 * 512 * 3 bytes} ) ,$$

which may reduce to

$$CEILING ( \frac{16000000 KBytes}{24.5 \; 76 Kbytes} ) ,$$

which is equal to 651,042 allocation units.

At 226, the memory system 210 may be accessed (e.g., read from and written to) in accordance with the determined allocation units for the sections of memory configured for the memory system 210.

At 229, an available capacity of the sections of memory in the memory system may be monitored in accordance with the determined allocation units. For example, the host system 205 may monitor the quantity of allocation units (of the available allocation units) that have been utilized to store data in each memory section.

At 232, the available capacity of the sections of memory in the memory system may similarly be monitored (e.g., by the memory system 210) in accordance with the determined allocation units.

Aspects of the process flow 200 may be implemented by a controller, among other components. Additionally, or alternatively, aspects of the process flow 200 may be implemented as instructions stored in memory (e.g., firmware stored in a memory coupled with a controller). For example, the instructions, when executed by a controller, may cause the controller to perform the operations of the process flow 200.

One or more of the operations described in the process flow 200 may be performed earlier or later, omitted, replaced, supplemented, or combined with another operation. Also, additional operations described herein may replace, supplement or be combined with one or more of the operations described in the process flow 200.

FIG. 3 shows an example of a message format that supports an accurate capacity adjustment factor in accordance with examples as disclosed herein.

The message format 300 provides a format for memory system messages (e.g., geometry descriptor messages) that indicate capacity adjustment factors for particular memory sections. The message format 300 may include the system code capacity adjustment factor field 305, the enhanced memory type capacity adjustment fields (e.g., the first enhanced memory type capacity adjustment field 310-1 through the Nth enhanced memory type capacity adjustment field 310-N), and the capacity adjustment factor representation field 315.

The system code capacity adjustment factor field 305 may be configured to convey a capacity adjustment factor for a section of memory allocated to storing system code for a host system. In some examples, a beginning of the system code capacity adjustment factor field 305 may be offset from a beginning of a memory system message by a first amount (e.g., offset by 24 hex). The first enhanced memory type capacity adjustment field 310-1 may be configured to convey a capacity adjustment factor for a section of memory allocated to storing data of a first type (e.g., low-latency data) for a host system. The second enhanced memory type capacity adjustment field 310-2 may be configured to convey a capacity adjustment factor for a section of memory allocated to storing data of a second type (e.g., critical-reliability data) for a host system, and so on. The enhanced memory type capacity adjustment fields may similarly be offset from a beginning of the memory system by respective offsets.

The capacity adjustment factor representation field 315 may be configured to convey an indication of a format for the capacity adjustment factor. That is, the capacity adjustment factor representation field 315 may be configured to whether a first technique (e.g., an accurate numerator/denominator technique) or a second technique (e.g., a less-accurate whole number/fractional number technique) is configured for conveying the capacity adjustment factors for the sections of memory indicated in a memory system message configured in accordance with the message format 300. In some examples, the capacity adjustment factor representation field 315 is included at an end of the message format 300. In such cases, existing host systems that do not support the accurate numerator/denominator technique may stop reading a memory system message just prior to the beginning of the capacity adjustment factor representation field 315, while host systems that do support the accurate numerator/denominator technique may read the capacity adjustment factor representation field 315 to determine which of the first technique or the second technique is being used to convey the capacity adjustment factors for the sections of memory indicated in the memory system message.

An example memory system message is provided as follows, where the size of the fields may be given in bytes, and the system code capacity adjustment factor field 305 may be located at offset and be referred to as the wSystemCodeCapAdjFac field; a non-persistent memory field may be located at offset 2Ah and may be referred to as the wNonPersistCapAdjFac field; the first enhanced memory type capacity adjustment field 310-1 may be located at offset 30h and may be referred to as the wEnhanced1CapAdjFac field; the second enhanced memory type capacity adjustment field 310-2 field may be located at offset 30h and may be referred to as the wEnhanced2CapAdjFac field; a third enhanced memory type capacity adjustment field may be located at offset 36h and may be referred to as the wEnhanced3CapAdjFac field; the Nth enhanced memory type capacity adjustment field 310-N (where N=4) may be located at offset 3Ch and may be referred to as the wEnhanced4CapAdjFac field; and the capacity adjustment factor representation field 315 may be located at offset 57h and may be referred to as the bCapAdjFacRepresentation field.

| Offset | Size | Value | Description |
|---|---|---|---|
| . . . | . . . | . . . | . . . |
| 24h | 2 | Device | Capacity Adjustment Factor for the System Code memory type. |
| | | specific | This parameter is the ratio between the capacity obtained with |
| | | | the Normal memory type and the capacity obtained with the |
| | | | System Code memory type for the same amount of allocation |
| | | | units. |
| | | | CapAdjFactor = Capacity_{NormalMem} / Capacity_{SystemCode} |
| | | | If bCapAdjFacRepresentation == 0h |
| | | | wSystemCodeCapAdjFac = INT(256 × CapAdjFactor) |
| | | | Else |
| | | | wSystemCodeCapAdjFac [15:8] = num(CapAdjFactor) |
| | | | wSystemCodeCapAdjFac [7:0] = denom(CapAdjFactor) |
| 2Ah | 2 | Device | Capacity Adjustment Factor for the Non-Persistent memory |
| | | specific | type. |
| | | | This parameter is the ratio between the capacity obtained with |
| | | | the Normal memory type and the capacity obtained with the |
| | | | Non-Persistent memory type for the same amount of allocation |
| | | | units. |
| | | | CapAdjFactor = Capacity_{NormalMem} / Capacity_{NonPersist} |
| | | | If bCapAdjFacRepresentation == 0h |
| | | | wNonPersistCapAdjFac = INT(256 × CapactiyAdjFactor) |
| | | | Else |
| | | | wNonPersistCapAdjFac[15:8] = num(CapAdjFactor) |
| | | | wNonPersistCapAdjFac[7:0] = denom(CapAdjFactor) |
| 30h | 2 | Device | Capacity Adjustment Factor for the Enhanced memory type 1. |
| | | specific | This parameter is the ratio between the capacity obtained with |
| | | | the Normal memory type and the capacity obtained with the |
| | | | Enhanced memory type 1 for the same amount of allocation |
| | | | units. |
| | | | CapAdjFactor = Capacity_{NormalMem} / Capacity_{Enhanced1} |
| | | | If bCapAdjFacRepresentation == 0h |
| | | | wEnhanced1CapAdjFac = INT(256 × CapAdjFactor) |
| | | | Else |
| | | | wEnhanced1CapAdjFac [15:8] = num(CapAdjFactor) |
| | | | wEnhanced1CapAdjFac [7:0] = denom(CapAdjFactor) |
| 36h | 2 | Device | Capacity Adjustment Factor for the Enhanced memory type 2. |
| | | specific | This parameter is the ratio between the capacity obtained with |
| | | | the Normal memory type and the capacity obtained with the |
| | | | Enhanced memory type 2 for the same amount of allocation |
| | | | units. |
| | | | CapAdjFactor = Capacity_{NormalMem} / Capacity_{Enhanced2} |
| | | | If bCapAdjFacRepresentation == 0h |
| | | | wEnhanced2CapAdjFac = INT(256 × CapAdjFactor) |
| | | | Else |
| | | | wEnhanced2CapAdjFac [15:8] = num(CapAdjFactor) |
| | | | wEnhanced2CapAdjFac [7:0] = denom(CapAdjFactor) |
| 3Ch | 2 | Device | Capacity Adjustment Factor for the Enhanced memory type 3. |
| | | specific | This parameter is the ratio between the capacity obtained with |
| | | | the Normal memory type and the capacity obtained with the |
| | | | Enhanced memory type 3 for the same amount of allocation |
| | | | units. |
| | | | CapAdjFactor = Capacity_{NormalMem} / Capacity_{Enhanced3} |
| | | | If bCapAdjFacRepresentation == 0h |
| | | | wEnhanced3CapAdjFac = INT(256 × CapAdjFactor) |
| | | | Else |
| | | | wEnhanced3CapAdjFac [15:8] = num(CapAdjFactor) |
| | | | wEnhanced3CapAdjFac [7:0] = denom(CapAdjFactor) |
| 42h | 2 | Device | Capacity Adjustment Factor for the Enhanced memory type 4. |
| | | specific | This parameter is the ratio between the capacity obtained with |
| | | | the Normal memory type and the capacity obtained with the |
| | | | Enhanced memory type 4 for the same amount of allocation |
| | | | units. |
| | | | CapAdjFactor = Capacity_{NormalMem} / Capacity_{Enhanced4} |
| | | | If bCapAdjFacRepresentation == 0h |
| | | | wEnhanced4CapAdjFac = INT(256 × CapAdjFactor) |
| | | | Else |
| | | | wEnhanced4CapAdjFac [15:8] = num(CapAdjFactor) |
| | | | wEnhanced4CapAdjFac [7:0] = denom(CapAdjFactor) |
| . . . | . . . | . . . | . . . |
| 57h | 1 | Device | CapAdjFactor representation format |
| | | specific | 00h: Legacy 256ths |
| | | | 01h: Simple Fraction |
| | | | Others: Reserved |

In one example, the system code memory section may include QLCs and may be configured for TLC programming (which may be referred to as TLC-on-QLC). In such cases, the numerator of the CapAdjFactor (Capacity_{NormalMem}) may be equal to four (4) and the denominator of the CapAdjFactor (Capacity_{systemcode}) may be equal to three (3). In such cases, if the capacity adjustment factor representation field 315 indicates that the less-accurate whole number/fractional number technique is being used (e.g., by having a value of 0h), then the value of the system code capacity adjustment factor field 305 may be equal to INT(256×4/3), which yields hex: 0155; bin: whole number component (0000 0001) fractional number component (0101 0101); dec:

$$1 \frac{85}{256}$$

(corresponding to 1.3320). Host systems that do not support processing the capacity adjustment factor representation field 315 may use the whole number/fractional number technique by default.

Alternatively, if the capacity adjustment factor representation field 315 indicates that the accurate numerator/denominator technique is being used (e.g., by having a value other 0h), then the value of the system code capacity adjustment factor field 305 may be equal to hex: 0403 (bin: numerator component (0000 0100) denominator component (0000 0011)) which may be processed by a host system that receives the memory system message. In such cases, the host system may accurately (e.g., with full accuracy) determine (e.g., by dividing the numerator by the denominator) the system code capacity adjustment factor as 4/3 (which corresponds to 1.3333).

In an example where the capacity adjustment factor representation field 315 is omitted from the message format 300, the memory system message may be modified so that the values of the numerator and the denominator are backwards compatible with the whole number/fractional number technique. For example, the wSystemCodeCapAdjFac field at offset 24h may be modified to include a first sub-field bSystemCodeCapAdjNumerator at offset 24h and a second sub-field bSystemCodeCapAdjDenominator at offset 25h. In such cases, the non-persistent and enhanced memory type fields may be similarly modified.

| Offset | Size | Value | Description |
|---|---|---|---|
| . . . | . . . | . . . | . . . |
| 24h | 1 | Device | Capacity Adjustment Factor for the System Code memory type. |
| | | specific | bSystemCodeCapAdjNumerator is 1-based. |
| | | | bSystemCodeCapAdjDenominator is 0-based. |
| 25h | 1 | Device | Numerator and Denominator together create the ratio between |
| | | specific | the capacity obtained using Normal memory type and the |
| | | | capacity obtained using System Code memory type for the same |
| | | | number of allocation units. |
| | | | CapAdjFactor = bSystemCodeCapAdjNumerator/ |
| | | | (bSystemCodeCapAdjDenominator + 1) |
| | | | For legacy host systems: |
| | | | wSystemCodeCapAdjFac = INT(256 × CapAdjFactor) |

In one example (similar to the above example), the system code memory section may include QLCs and may be configured for TLC programming. In such cases, the numerator of the system code capacity adjustment factor may be equal to four (4) and the denominator of the system code capacity adjustment factor may be equal to three (3). In such cases, the value of the system code capacity adjustment factor field 305 may be equal to hex: 0402 (bin: 0000 0100 0000 0010), where the numerator value of four (4) may be represented by the hex value of 04h (because the numerator is 1-based) and the denominator value of three (3) may be represented by the hex value of 02h (because the denominator is 0-based). The values in the sub-fields of the system code capacity adjustment factor field 305 may be processed by a first set of host systems that receives the memory system message. In such cases, the first set of host system may determine (e.g., by dividing the numerator by the denominator) the system code capacity adjustment factor as

$$\frac{4}{2 + 1}$$

(which corresponds to 1.3333).

For a second set of host systems (that do not support the numerator/denominator technique), wSystemCodeCapAdjFac may be calculated (e.g., by the memory system) from the CapAdjFactor obtained from the numerator and denominator values, and the bSystemCodeCapAdjNumerator and bSystemCodeCapAdjDenominator may together convey the system code capacity adjustment factor wSystemCodeCapAdjFac, where wSystemCodeCapAdjFac=INT(256×CapAdjFactor). That is, for the second set of host systems, the system code capacity adjustment factor may be determined using the CapAdjFactor obtained from the numerator and denominator, and the value of the system code capacity adjustment factor field 305 may be equal to INT(256×4/3), which yields hex: 0155; bin: whole number component (0000 0001) fractional number component (0101 0101); dec:

$$1 \frac{85}{256}$$

(corresponding to 1.3320).

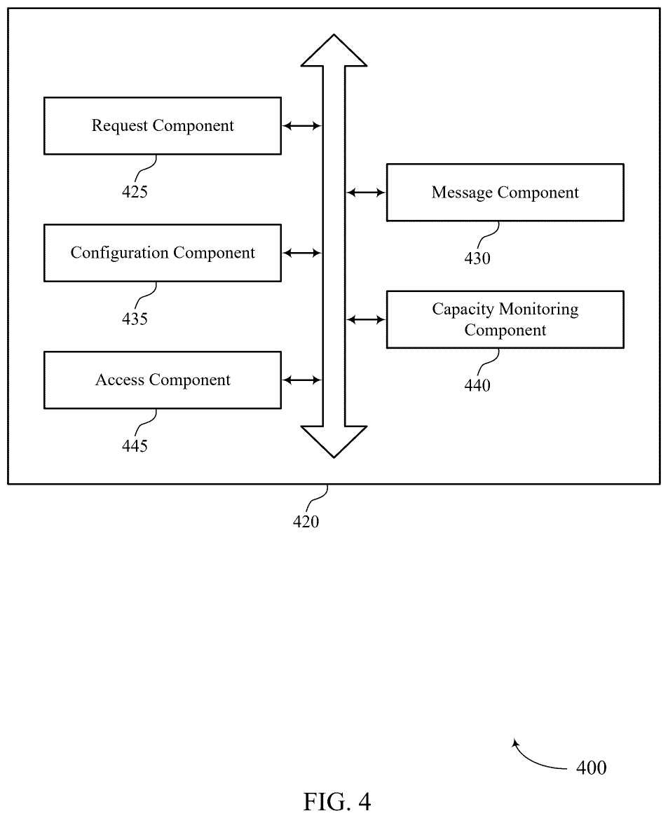

FIG. 4 shows a block diagram 400 of a memory system 420 that supports an accurate capacity adjustment factor in accordance with examples as disclosed herein. The memory system 420 may be an example of aspects of a memory system as described with reference to FIGS. 1 through 3. The memory system 420, or various components thereof, may be an example of means for performing various aspects of accurate capacity adjustment factor as described herein. For example, the memory system 420 may include a request component 425, a message component 430, a configuration component 435, a capacity monitoring component 440, an access component 445, or any combination thereof. Each of these components, or components of subcomponents thereof (e.g., one or more processors, one or more memories), may communicate, directly or indirectly, with one another (e.g., via one or more buses).

The request component 425 may be configured as or otherwise support a means for receiving, from a host system, a request for the memory system to signal a capacity of the memory system. The message component 430 may be configured as or otherwise support a means for transmitting, to the host system based at least in part on the request, a message indicating a capacity of a section of memory in the memory system that includes the plurality of multiple-level cells, the message including a first indication of a potential capacity of the plurality of multiple-level cells and a second indication of a configured capacity of the plurality of multiple-level cells.

In some examples, the configuration component 435 may be configured as or otherwise support a means for configuring, prior to receiving the request, a programming mode for the section of memory including the plurality of multiple-level cells, where a first quantity of levels programmable for the plurality of multiple-level cells is greater than or equal to a second quantity of levels programmable by the programming mode, the potential capacity of the plurality of multiple-level cells corresponds to the first quantity of levels programmable for the plurality of multiple-level cells, and the configured capacity of the plurality of multiple-level cells corresponds to the second quantity of levels programmable by the programming mode.

In some examples, the configuration component 435 may be configured as or otherwise support a means for configuring, prior to receiving the request, the section of memory as a system code memory type, a non-persistent memory type, or an enhanced memory type.

In some examples, the capacity monitoring component 440 may be configured as or otherwise support a means for monitoring, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells. In some examples, the access component 445 may be configured as or otherwise support a means for accessing the section of memory based at least in part on the monitored capacity.

In some examples, a first field of the message includes the first indication of the potential capacity of the plurality of multiple-level cells, and a second field of the message includes the second indication of the configured capacity of the plurality of multiple-level cells.

In some examples, the message further includes a third field that includes an indication of whether the first field of the message indicates the potential capacity of the plurality of multiple-level cells and the second field of the message indicates the configured capacity of the plurality of multiple-level cells, or the first field of the message and the second field of the message together indicate a capacity adjustment factor for the section of memory that includes a whole number component and a fractional number component capable of representing fractional numbers with a resolution of 1/256.

In some examples, for a first set of host systems, the first field of the message includes a value of a first parameter for indicating the potential capacity of the plurality of multiple-level cells and the second field of the message includes a value of a second parameter for indicating the configured capacity of the plurality of multiple-level cells, and, for a second set of host systems, the first field of the message and the second field of the message together include a value of a third parameter for indicating a capacity adjustment factor for the section of memory that is obtained based at least in part dividing the potential capacity of the plurality of multiple-level cells by the configured capacity of the plurality of multiple-level cells, the value of the first parameter indicating a whole number component of the capacity adjustment factor and the value of the second parameter indicating a fractional number component of the capacity adjustment factor.

In some examples, the second field of the message is capable of representing the fractional number component with a resolution of 1/256.

In some examples, the configuration component 435 may be configured as or otherwise support a means for configuring, prior to receiving the request, a tri-level programming mode for the section of memory including the plurality of multiple-level cells, the plurality of multiple-level cells including quad-level cells, where the potential capacity of the plurality of multiple-level cells is a multiple of four, and the configured capacity of the plurality of multiple-level cells is a multiple of three.

In some examples, for a first set of host systems, a first field of the message indicates the potential capacity of the plurality of multiple-level cells as being equal to four and a second field of the message indicates the configured capacity of the plurality of multiple-level cells as being equal to three, corresponding to a capacity adjustment factor equal to 1.333 repeating, and, for a second set of host systems, the first field of the message and the second field of the message together indicate the capacity adjustment factor as being equal to 1.332.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

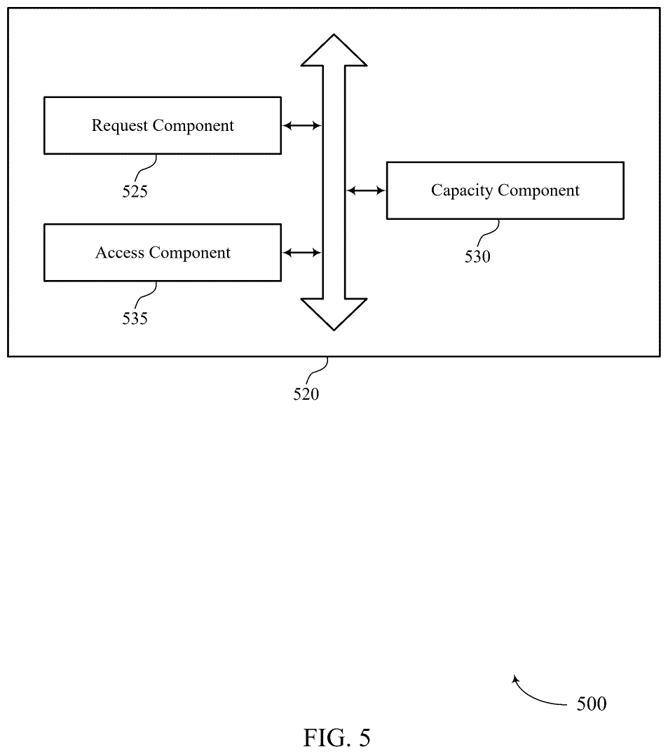

FIG. 5 shows a block diagram 500 of a host system 520 that supports an accurate capacity adjustment factor in accordance with examples as disclosed herein. The host system 520 may be an example of aspects of a host system as described with reference to FIGS. 1 through 3. The host system 520, or various components thereof, may be an example of means for performing various aspects of accurate capacity adjustment factor as described herein. For example, the host system 520 may include a request component 525, a capacity component 530, an access component 535, or any combination thereof. Each of these components, or components of subcomponents thereof (e.g., one or more processors, one or more memories), may communicate, directly or indirectly, with one another (e.g., via one or more buses).

The request component 525 may be configured as or otherwise support a means for transmitting, to a memory system including a plurality of multiple-level cells, a request for the memory system to signal a capacity of the memory system. The capacity component 530 may be configured as or otherwise support a means for receiving, from the memory system, in response to the request, a message indicating a capacity of a section of memory in the memory system that includes the plurality of multiple-level cells, where the message includes a first indication of a potential capacity of the plurality of multiple-level cells and a second indication of a configured capacity of the plurality of multiple-level cells.

In some examples, the capacity component 530 may be configured as or otherwise support a means for determining a capacity adjustment factor for the section of memory. In some examples, the capacity component 530 may be configured as or otherwise support a means for reading a first field of the message that includes the first indication of the potential capacity of the plurality of multiple-level cells, where a first value of the potential capacity of the plurality of multiple-level cells is obtained based at least in part on reading the first field of the message. In some examples, the capacity component 530 may be configured as or otherwise support a means for reading a second field of the message that includes the second indication of the configured capacity of the plurality of multiple-level cells, where a second value of the configured capacity of the plurality of multiple-level cells is obtained based at least in part on reading the second field of the message. In some examples, the capacity component 530 may be configured as or otherwise support a means for dividing, based at least in part on obtaining the first value and the second value, the first value by the second value to obtain the capacity adjustment factor, where the capacity adjustment factor is determined based at least in part on the reading and dividing.

In some examples, the capacity component 530 may be configured as or otherwise support a means for determining a capacity adjustment factor for the section of memory. In some examples, the capacity component 530 may be configured as or otherwise support a means for reading a value of a first parameter associated with a first field of the message including the first indication of the potential capacity of the plurality of multiple-level cells, where a whole number component of the capacity adjustment factor is obtained based at least in part on reading the first field of the message. In some examples, the capacity component 530 may be configured as or otherwise support a means for reading a value of a second parameter associated with a second field of the message including the second indication of the configured capacity of the plurality of multiple-level cells, where a fractional number component of the capacity adjustment factor is obtained based at least in part on reading the value of the second field of the message, the fractional number component is a factor of 1/256, where the capacity adjustment factor is determined based at least in part on the reading a.

In some examples, the capacity component 530 may be configured as or otherwise support a means for determining, based at least in part on a third field in the message, whether to determine a capacity adjustment factor for the section of memory by obtaining a whole number component from a value of a first parameter associated with a first field of the message including the first indication of the potential capacity of the plurality of multiple-level cells and a fractional number component from a value of a second parameter associated with a second field of the message including the second indication of the configured capacity of the plurality of multiple-level cells, or calculating the whole number component and the fractional number component by dividing the value of the first field of the message by the value of the second field of the message.

In some examples, the capacity component 530 may be configured as or otherwise support a means for monitoring, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells. In some examples, the access component 535 may be configured as or otherwise support a means for accessing the section of memory based at least in part on the monitored capacity.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

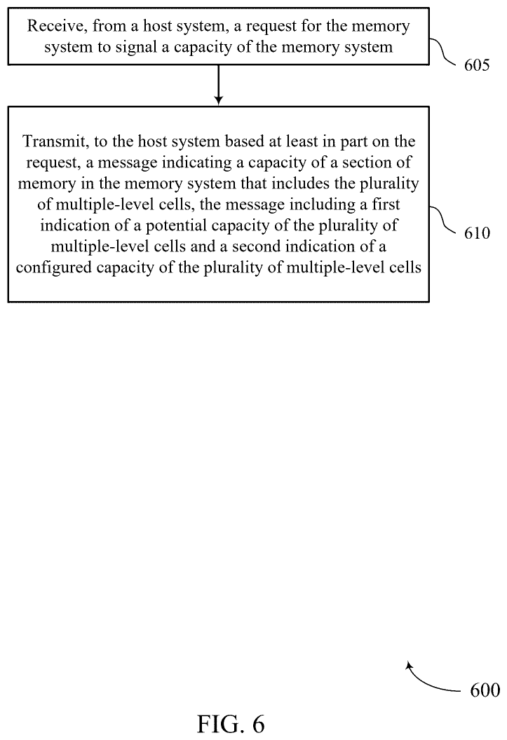

FIG. 6 shows a flowchart illustrating a method 600 that supports an accurate capacity adjustment factor in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, from a host system, a request for the memory system to signal a capacity of the memory system. In some examples, aspects of the operations of 605 may be performed by a request component 425 as described with reference to FIG. 4.

At 610, the method may include transmitting, to the host system based at least in part on the request, a message indicating a capacity of a section of memory in the memory system that includes the plurality of multiple-level cells, the message including a first indication of a potential capacity of the plurality of multiple-level cells and a second indication of a configured capacity of the plurality of multiple-level cells. In some examples, aspects of the operations of 610 may be performed by a message component 430 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, from a host system, a request for the memory system to signal a capacity of the memory system and transmitting, to the host system based at least in part on the request, a message indicating a capacity of a section of memory in the memory system that includes the plurality of multiple-level cells, the message including a first indication of a potential capacity of the plurality of multiple-level cells and a second indication of a configured capacity of the plurality of multiple-level cells.

Aspect 2: The method, apparatus, or non-transitory computer-readable medium of aspect 1, further including operations, features, circuitry, logic, means, or instructions, or any combination thereof for configuring, prior to receiving the request, a programming mode for the section of memory including the plurality of multiple-level cells, where a first quantity of levels programmable for the plurality of multiple-level cells is greater than or equal to a second quantity of levels programmable by the programming mode, the potential capacity of the plurality of multiple-level cells corresponds to the first quantity of levels programmable for the plurality of multiple-level cells, and the configured capacity of the plurality of multiple-level cells corresponds to the second quantity of levels programmable by the programming mode.

Aspect 3: The method, apparatus, or non-transitory computer-readable medium of any of aspects 1 through 2, further including operations, features, circuitry, logic, means, or instructions, or any combination thereof for configuring, prior to receiving the request, the section of memory as a system code memory type, a non-persistent memory type, or an enhanced memory type.

Aspect 4: The method, apparatus, or non-transitory computer-readable medium of any of aspects 1 through 3, further including operations, features, circuitry, logic, means, or instructions, or any combination thereof for monitoring, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells and accessing the section of memory based at least in part on the monitored capacity.

Aspect 5: The method, apparatus, or non-transitory computer-readable medium of any of aspects 1 through 4, where a first field of the message includes the first indication of the potential capacity of the plurality of multiple-level cells, and a second field of the message includes the second indication of the configured capacity of the plurality of multiple-level cells.

Aspect 6: The method, apparatus, or non-transitory computer-readable medium of aspect 5, where the message further includes a third field that includes an indication of whether the first field of the message indicates the potential capacity of the plurality of multiple-level cells and the second field of the message indicates the configured capacity of the plurality of multiple-level cells, or the first field of the message and the second field of the message together indicate a capacity adjustment factor for the section of memory that includes a whole number component and a fractional number component capable of representing fractional numbers with a resolution of 1/256.

Aspect 7: The method, apparatus, or non-transitory computer-readable medium of any of aspects 5 through 6, where for a first set of host systems, the first field of the message includes a value of a first parameter for indicating the potential capacity of the plurality of multiple-level cells and the second field of the message includes a value of a second parameter for indicating the configured capacity of the plurality of multiple-level cells, and, for a second set of host systems, the first field of the message and the second field of the message together include a value of a third parameter for indicating a capacity adjustment factor for the section of memory that is obtained based at least in part dividing the potential capacity of the plurality of multiple-level cells by the configured capacity of the plurality of multiple-level cells, the value of the first parameter indicating a whole number component of the capacity adjustment factor and the value of the second parameter indicating a fractional number component of the capacity adjustment factor.

Aspect 8: The method, apparatus, or non-transitory computer-readable medium of aspect 7, where the second field of the message is capable of representing the fractional number component with a resolution of 1/256.

Aspect 9: The method, apparatus, or non-transitory computer-readable medium of any of aspects 1 through 8, further including operations, features, circuitry, logic, means, or instructions, or any combination thereof for configuring, prior to receiving the request, a tri-level programming mode for the section of memory including the plurality of multiple-level cells, the plurality of multiple-level cells including quad-level cells, where the potential capacity of the plurality of multiple-level cells is a multiple of four, and the configured capacity of the plurality of multiple-level cells is a multiple of three.

Aspect 10: The method, apparatus, or non-transitory computer-readable medium of aspect 9, where for a first set of host systems, a first field of the message indicates the potential capacity of the plurality of multiple-level cells as being equal to four and a second field of the message indicates the configured capacity of the plurality of multiple-level cells as being equal to three, corresponding to a capacity adjustment factor equal to 1.333 repeating, and, for a second set of host systems, the first field of the message and the second field of the message together indicate the capacity adjustment factor as being equal to 1.332.

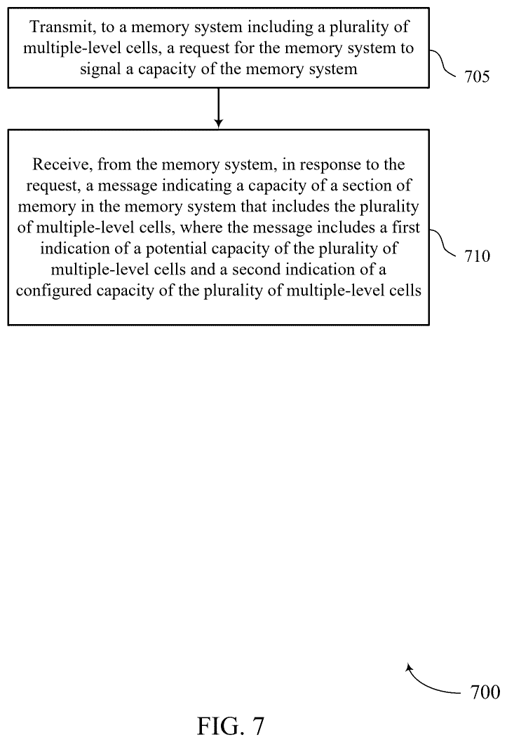

FIG. 7 shows a flowchart illustrating a method 700 that supports an accurate capacity adjustment factor in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include transmitting, to a memory system including a plurality of multiple-level cells, a request for the memory system to signal a capacity of the memory system. In some examples, aspects of the operations of 705 may be performed by a request component 525 as described with reference to FIG. 5.

At 710, the method may include receiving, from the memory system, in response to the request, a message indicating a capacity of a section of memory in the memory system that includes the plurality of multiple-level cells, where the message includes a first indication of a potential capacity of the plurality of multiple-level cells and a second indication of a configured capacity of the plurality of multiple-level cells. In some examples, aspects of the operations of 710 may be performed by a capacity component 530 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for transmitting, to a memory system including a plurality of multiple-level cells, a request for the memory system to signal a capacity of the memory system and receiving, from the memory system, in response to the request, a message indicating a capacity of a section of memory in the memory system that includes the plurality of multiple-level cells, where the message includes a first indication of a potential capacity of the plurality of multiple-level cells and a second indication of a configured capacity of the plurality of multiple-level cells.

Aspect 12: The method, apparatus, or non-transitory computer-readable medium of aspect 11, further including operations, features, circuitry, logic, means, or instructions, or any combination thereof for determining a capacity adjustment factor for the section of memory; reading a first field of the message that includes the first indication of the potential capacity of the plurality of multiple-level cells, where a first value of the potential capacity of the plurality of multiple-level cells is obtained based at least in part on reading the first field of the message; reading a second field of the message that includes the second indication of the configured capacity of the plurality of multiple-level cells, where a second value of the configured capacity of the plurality of multiple-level cells is obtained based at least in part on reading the second field of the message; and dividing, based at least in part on obtaining the first value and the second value, the first value by the second value to obtain the capacity adjustment factor, where the capacity adjustment factor is determined based at least in part on the reading and dividing.

Aspect 13: The method, apparatus, or non-transitory computer-readable medium of any of aspects 11 through 12, further including operations, features, circuitry, logic, means, or instructions, or any combination thereof for determining a capacity adjustment factor for the section of memory; reading a value of a first parameter associated with a first field of the message including the first indication of the potential capacity of the plurality of multiple-level cells, where a whole number component of the capacity adjustment factor is obtained based at least in part on reading the first field of the message; and reading a value of a second parameter associated with a second field of the message including the second indication of the configured capacity of the plurality of multiple-level cells, where a fractional number component of the capacity adjustment factor is obtained based at least in part on reading the value of the second field of the message, the fractional number component is a factor of 1/256, where the capacity adjustment factor is determined based at least in part on the reading a.

Aspect 14: The method, apparatus, or non-transitory computer-readable medium of any of aspects 11 through 13, further including operations, features, circuitry, logic, means, or instructions, or any combination thereof for determining, based at least in part on a third field in the message, whether to determine a capacity adjustment factor for the section of memory by obtaining a whole number component from a value of a first parameter associated with a first field of the message including the first indication of the potential capacity of the plurality of multiple-level cells and a fractional number component from a value of a second parameter associated with a second field of the message including the second indication of the configured capacity of the plurality of multiple-level cells, or calculating the whole number component and the fractional number component by dividing the value of the first field of the message by the value of the second field of the message.

Aspect 15: The method, apparatus, or non-transitory computer-readable medium of any of aspects 11 through 14, further including operations, features, circuitry, logic, means, or instructions, or any combination thereof for monitoring, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells and accessing the section of memory based at least in part on the monitored capacity.

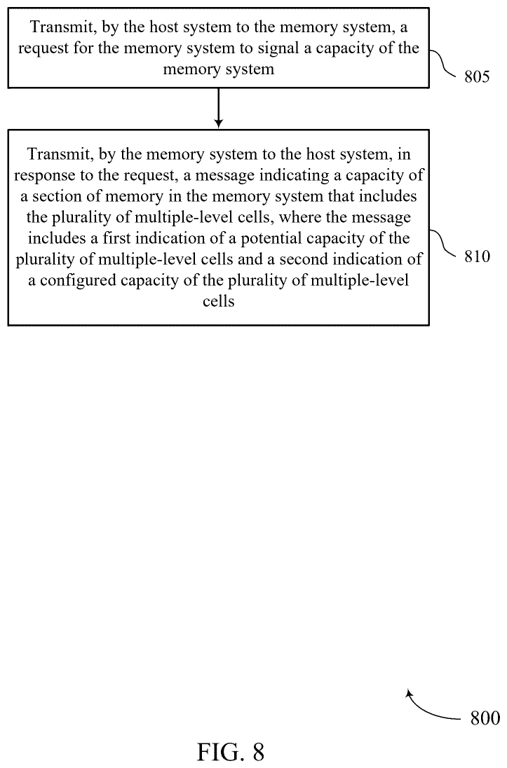

FIG. 8 shows a flowchart illustrating a method 800 that supports an accurate capacity adjustment factor in accordance with examples as disclosed herein. The operations of method 800 may be implemented by a system or its components as described herein. For example, the operations of method 800 may be performed by a system as described with reference to FIGS. 1 through 3. In some examples, a system may execute a set of instructions to control the functional elements of the device to perform the described functions. Additionally, or alternatively, the system may perform aspects of the described functions using special-purpose hardware.

At 805, the method may include transmitting, by the host system to the memory system, a request for the memory system to signal a capacity of the memory system.

At 810, the method may include transmit, by the memory system to the host system, in response to the request, a message indicating a capacity of a section of memory in the memory system that includes the plurality of multiple-level cells, where the message includes a first indication of a potential capacity of the plurality of multiple-level cells and a second indication of a configured capacity of the plurality of multiple-level cells.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 16: A method, apparatus, or non-transitory computer-readable medium including operations, features, circuitry, logic, means, or instructions, or any combination thereof for transmitting, by the host system to the memory system, a request for the memory system to signal a capacity of the memory system and transmit, by the memory system to the host system, in response to the request, a message indicating a capacity of a section of memory in the memory system that includes the plurality of multiple-level cells, where the message includes a first indication of a potential capacity of the plurality of multiple-level cells and a second indication of a configured capacity of the plurality of multiple-level cells.

Aspect 17: The method, apparatus, or non-transitory computer-readable medium of aspect 16, further including operations, features, circuitry, logic, means, or instructions, or any combination thereof for configuring, by the memory system prior to receiving the request, a programming mode for the section of memory including the plurality of multiple-level cells, where a first quantity of levels programmable for the plurality of multiple-level cells is greater than or equal to a second quantity of levels programmable by the programming mode, the potential capacity of the plurality of multiple-level cells corresponds to the first quantity of levels programmable for the plurality of multiple-level cells, and the configured capacity of the plurality of multiple-level cells corresponds to the second quantity of levels programmable by the programming mode.

Aspect 18: The method, apparatus, or non-transitory computer-readable medium of any of aspects 16 through 17, further including operations, features, circuitry, logic, means, or instructions, or any combination thereof for configuring, by the memory system prior to receiving the request, the section of memory as a system code memory type, a non-persistent memory type, or an enhanced memory type.

Aspect 19: The method, apparatus, or non-transitory computer-readable medium of any of aspects 16 through 18, further including operations, features, circuitry, logic, means, or instructions, or any combination thereof for monitoring, by the memory system during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells and accessing the section of memory based at least in part on the monitored capacity.

Aspect 20: The method, apparatus, or non-transitory computer-readable medium of any of aspects 16 through 19, further including operations, features, circuitry, logic, means, or instructions, or any combination thereof for determining, by the host system, a capacity adjustment factor for the section of memory; reading, by the host system, a first field of the message that includes the first indication of the potential capacity of the plurality of multiple-level cells, where a first value of the potential capacity of the plurality of multiple-level cells is obtained based at least in part on reading the first field of the message; reading, by the host system, a second field of the message that includes the second indication of the configured capacity of the plurality of multiple-level cells, where a second value of the configured capacity of the plurality of multiple-level cells is obtained based at least in part on reading the second field of the message; and dividing, by the host system based at least in part on obtaining the first value and the second value, the first value by the second value to obtain the capacity adjustment factor, where the capacity adjustment factor is determined based at least in part on the reading and the dividing.

Aspect 21: The method, apparatus, or non-transitory computer-readable medium of any of aspects 16 through 20, further including operations, features, circuitry, logic, means, or instructions, or any combination thereof for determining, by the host system, a capacity adjustment factor for the section of memory; reading, by the host system, a value of a first parameter associated with a first field of the message including the first indication of the potential capacity of the plurality of multiple-level cells, where a whole number component of the capacity adjustment factor is obtained based at least in part on reading the first field of the message; and reading, by the host system, a value of a second parameter associated with a second field of the message including the second indication of the configured capacity of the plurality of multiple-level cells, where a fractional number component of the capacity adjustment factor is obtained based at least in part on reading the value of the second field of the message, the fractional number component is a factor of 1/256, where the capacity adjustment factor is determined based at least in part on the reading.

Aspect 22: The method, apparatus, or non-transitory computer-readable medium of any of aspects 16 through 21, further including operations, features, circuitry, logic, means, or instructions, or any combination thereof for determining, by the host system based at least in part on a third field in the message, whether to determine a capacity adjustment factor for the section of memory by obtaining a whole number component from a value of a first parameter associated with a first field of the message including the first indication of the potential capacity of the plurality of multiple-level cells and fractional number component from a value of a second parameter of a second field of the message including the second indication of the configured capacity of the plurality of multiple-level cells, or calculating the whole number component and the fractional number component by dividing the value of the first field of the message by the value of the second field of the message.

Aspect 23: The method, apparatus, or non-transitory computer-readable medium of any of aspects 16 through 22, further including operations, features, circuitry, logic, means, or instructions, or any combination thereof for monitoring, by the host system during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells and accessing, by the host system, the section of memory based at least in part on the monitored capacity.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily doped, e.g., degenerate, semiconductor region. The source and drain may be separated by a lightly doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory arrays, wherein at least one of the one or more memory arrays comprises a plurality of multiple-level cells; and
processing circuitry coupled with the one or more memory arrays and configured to cause the memory system to:
receive, from a host system, a request for the memory system to signal a capacity of the memory system; and
transmit, to the host system based at least in part on the request, a message indicating a capacity of a section of memory in the memory system that comprises the plurality of multiple-level cells, the message comprising a first indication of a potential capacity of the plurality of multiple-level cells and a second indication of a configured capacity of the plurality of multiple-level cells.

2. The memory system of claim 1, wherein the processing circuitry is configured to cause the memory system to:
configure, prior to receiving the request, a programming mode for the section of memory comprising the plurality of multiple-level cells, wherein:
a first quantity of levels programmable for the plurality of multiple-level cells is greater than or equal to a second quantity of levels programmable by the programming mode,
the potential capacity of the plurality of multiple-level cells corresponds to the first quantity of levels programmable for the plurality of multiple-level cells, and
the configured capacity of the plurality of multiple-level cells corresponds to the second quantity of levels programmable by the programming mode.

3. The memory system of claim 1, wherein the processing circuitry is configured to cause the memory system to:
configure, prior to receiving the request, the section of memory as a system code memory type, a non-persistent memory type, or an enhanced memory type.

4. The memory system of claim 1, wherein the processing circuitry is further configured to cause the memory system to:
monitor, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells; and
access the section of memory based at least in part on the monitored capacity.

5. The memory system of claim 1, wherein:
a first field of the message comprises the first indication of the potential capacity of the plurality of multiple-level cells, and
a second field of the message comprises the second indication of the configured capacity of the plurality of multiple-level cells.

6. The memory system of claim 5, wherein the message further comprises a third field that comprises an indication of whether:
the first field of the message indicates the potential capacity of the plurality of multiple-level cells and the second field of the message indicates the configured capacity of the plurality of multiple-level cells, or
the first field of the message and the second field of the message together indicate a capacity adjustment factor for the section of memory that comprises a whole number component and a fractional number component capable of representing fractional numbers with a resolution of 1/256.

7. The memory system of claim 5, wherein:
for a first set of host systems, the first field of the message comprises a value of a first parameter for indicating the potential capacity of the plurality of multiple-level cells and the second field of the message comprises a value of a second parameter for indicating the configured capacity of the plurality of multiple-level cells, and
for a second set of host systems, the first field of the message and the second field of the message together comprise a value of a third parameter for indicating a capacity adjustment factor for the section of memory that is obtained based at least in part dividing the potential capacity of the plurality of multiple-level cells by the configured capacity of the plurality of multiple-level cells, the value of the first parameter indicating a whole number component of the capacity adjustment factor and the value of the second parameter indicating a fractional number component of the capacity adjustment factor.

8. The memory system of claim 7, wherein the second field of the message is capable of representing the fractional number component with a resolution of 1/256.

9. The memory system of claim 1, wherein the processing circuitry is configured to cause the memory system to:
configure, prior to receiving the request, a tri-level programming mode for the section of memory comprising the plurality of multiple-level cells, the plurality of multiple-level cells comprising quad-level cells, wherein:
the potential capacity of the plurality of multiple-level cells is a multiple of four, and
the configured capacity of the plurality of multiple-level cells is a multiple of three.

10. The memory system of claim 9, wherein:
for a first set of host systems, a first field of the message indicates the potential capacity of the plurality of multiple-level cells as being equal to four and a second field of the message indicates the configured capacity of the plurality of multiple-level cells as being equal to three, corresponding to a capacity adjustment factor equal to 1.333 repeating, and
for a second set of host systems, the first field of the message and the second field of the message together indicate the capacity adjustment factor as being equal to 1.332.

11. A host system, comprising:
processing circuitry configured to cause the host system to:
transmit, to a memory system comprising a plurality of multiple-level cells, a request for the memory system to signal a capacity of the memory system; and
receive, from the memory system, in response to the request, a message indicating a capacity of a section of memory in the memory system that comprises the plurality of multiple-level cells, wherein the message comprises a first indication of a potential capacity of the plurality of multiple-level cells and a second indication of a configured capacity of the plurality of multiple-level cells.

12. The host system of claim 11, wherein the processing circuitry is further configured to cause the host system to:
determine a capacity adjustment factor for the section of memory, wherein, to determine the capacity adjustment factor, the processing circuitry is further configured to cause the host system to:
read a first field of the message that comprises the first indication of the potential capacity of the plurality of multiple-level cells, wherein a first value of the potential capacity of the plurality of multiple-level cells is obtained based at least in part on reading the first field of the message;
read a second field of the message that comprises the second indication of the configured capacity of the plurality of multiple-level cells, wherein a second value of the configured capacity of the plurality of multiple-level cells is obtained based at least in part on reading the second field of the message; and
divide, based at least in part on obtaining the first value and the second value, the first value by the second value to obtain the capacity adjustment factor.

13. The host system of claim 11, wherein the processing circuitry is further configured to cause the host system to:
determine a capacity adjustment factor for the section of memory, wherein, to determine the capacity adjustment factor, the processing circuitry is further configured to cause the host system to:
read a value of a first parameter associated with a first field of the message comprising the first indication of the potential capacity of the plurality of multiple-level cells, wherein a whole number component of the capacity adjustment factor is obtained based at least in part on reading the first field of the message; and
read a value of a second parameter associated with a second field of the message comprising the second indication of the configured capacity of the plurality of multiple-level cells, wherein a fractional number component of the capacity adjustment factor is obtained based at least in part on reading the value of the second field of the message, the fractional number component is a factor of 1/256.

14. The host system of claim 11, wherein the processing circuitry is further configured to cause the host system to:
determine, based at least in part on a third field in the message, whether to determine a capacity adjustment factor for the section of memory by:
obtaining a whole number component from a value of a first parameter associated with a first field of the message comprising the first indication of the potential capacity of the plurality of multiple-level cells and a fractional number component from a value of a second parameter associated with a second field of the message comprising the second indication of the configured capacity of the plurality of multiple-level cells, or
calculating the whole number component and the fractional number component by dividing the value of the first field of the message by the value of the second field of the message.

15. The host system of claim 11, wherein the processing circuitry is further configured to cause the host system to:
monitor, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells; and
access the section of memory based at least in part on the monitored capacity.

16. A system, comprising:
a memory system comprising a plurality of multiple-level cells; and
a host system configured to transmit, to the memory system, a request for the memory system to signal a capacity of the memory system,
wherein the memory system is configured to transmit, to the host system, in response to the request, a message indicating a capacity of a section of memory in the memory system that comprises the plurality of multiple-level cells, wherein the message comprises a first indication of a potential capacity of the plurality of multiple-level cells and a second indication of a configured capacity of the plurality of multiple-level cells.

17. The system of claim 16, wherein the memory system is further configured to:
configure, prior to receiving the request, a programming mode for the section of memory comprising the plurality of multiple-level cells, wherein:
a first quantity of levels programmable for the plurality of multiple-level cells is greater than or equal to a second quantity of levels programmable by the programming mode,
the potential capacity of the plurality of multiple-level cells corresponds to the first quantity of levels programmable for the plurality of multiple-level cells, and
the configured capacity of the plurality of multiple-level cells corresponds to the second quantity of levels programmable by the programming mode.

18. The system of claim 16, wherein the memory system is further configured to:
configure, prior to receiving the request, the section of memory as a system code memory type, a non-persistent memory type, or an enhanced memory type.

19. The system of claim 16, wherein the memory system is further configured to:
monitor, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells; and
access the section of memory based at least in part on the monitored capacity.

20. The system of claim 16, wherein the host system is further configured to:
determine a capacity adjustment factor for the section of memory, wherein, to determine the capacity adjustment factor, the host system is further configured to cause the host system to:
read a first field of the message that comprises the first indication of the potential capacity of the plurality of multiple-level cells, wherein a first value of the potential capacity of the plurality of multiple-level cells is obtained based at least in part on reading the first field of the message;
read a second field of the message that comprises the second indication of the configured capacity of the plurality of multiple-level cells, wherein a second value of the configured capacity of the plurality of multiple-level cells is obtained based at least in part on reading the second field of the message; and
divide, based at least in part on obtaining the first value and the second value, the first value by the second value to obtain the capacity adjustment factor.

21. The system of claim 16, wherein the host system is further configured to:
determine a capacity adjustment factor for the section of memory, wherein, to determine the capacity adjustment factor, the host system is further configured to cause the host system to:
read a value of a first parameter associated with a first field of the message comprising the first indication of the potential capacity of the plurality of multiple-level cells, wherein a whole number component of the capacity adjustment factor is obtained based at least in part on reading the first field of the message; and
read a value of a second parameter associated with a second field of the message comprising the second indication of the configured capacity of the plurality of multiple-level cells, wherein a fractional number component of the capacity adjustment factor is obtained based at least in part on reading the value of the second field of the message, the fractional number component is a factor of 1/256.

22. The system of claim 16, wherein the host system is further configured to:
determine, based at least in part on a third field in the message, whether to determine a capacity adjustment factor for the section of memory by:
obtaining a whole number component from a value of a first parameter associated with a first field of the message comprising the first indication of the potential capacity of the plurality of multiple-level cells and fractional number component from a value of a second parameter of a second field of the message comprising the second indication of the configured capacity of the plurality of multiple-level cells, or
calculating the whole number component and the fractional number component by dividing the value of the first field of the message by the value of the second field of the message.

23. The system of claim 16, wherein the host system is further configured to:
monitor, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells; and
access the section of memory based at least in part on the monitored capacity.

24. A non-transitory, computer-readable medium storing code comprising instructions executable by one or more processors, individually or collectively, of a memory system to cause the memory system to:
receive, from a host system, a request for the memory system to signal a capacity of the memory system, the memory system comprising a plurality of multiple-level cells; and
transmit, to the host system, in response to the request, a message indicating a capacity of a section of memory in the memory system that comprises the plurality of multiple-level cells, wherein the message comprises a first indication of a potential capacity of the plurality of multiple-level cells and a second indication of a configured capacity of the plurality of multiple-level cells.

25. The non-transitory, computer-readable medium of claim 24, wherein the instructions are further executable by the one or more processors, individually or collectively, to cause the memory system to:
configure, prior to receiving the request, a programming mode for the section of memory comprising the plurality of multiple-level cells, wherein:
a first quantity of levels programmable for the plurality of multiple-level cells is greater than or equal to a second quantity of levels programmable by the programming mode,
the potential capacity of the plurality of multiple-level cells corresponds to the first quantity of levels programmable for the plurality of multiple-level cells, and
the configured capacity of the plurality of multiple-level cells corresponds to the second quantity of levels programmable by the programming mode.

26. The non-transitory, computer-readable medium of claim 24, wherein the instructions are further executable by the one or more processors, individually or collectively, to cause the memory system to:
configure, prior to receiving the request, the section of memory as a system code memory type, a non-persistent memory type, or an enhanced memory type.

27. The non-transitory, computer-readable medium of claim 24, wherein the instructions are further executable by the one or more processors, individually or collectively, to cause the memory system to:
monitor, during operation of the memory system, the capacity of the section of memory based at least in part on a capacity adjustment factor for the section of memory obtained using the first indication of the potential capacity of the plurality of multiple-level cells and the second indication of the configured capacity of the plurality of multiple-level cells; and
access the section of memory based at least in part on the monitored capacity.

28. The non-transitory, computer-readable medium of claim 24, wherein the instructions are further executable by the one or more processors, individually or collectively, to cause the memory system to:
configure, prior to receiving the request, a tri-level programming mode for the section of memory comprising the plurality of multiple-level cells, the plurality of multiple-level cells comprising quad-level cells, wherein:
the potential capacity of the plurality of multiple-level cells is a multiple of four, and
the configured capacity of the plurality of multiple-level cells is a multiple of three.

29. A non-transitory, computer-readable medium storing code comprising instructions executable by one or more processors, individually or collectively, of a host system to cause the host system to:
transmit, to a memory system comprising a plurality of multiple-level cells, a request for the memory system to signal a capacity of the memory system; and
receive, from the host system, in response to the request, a message indicating a capacity of a section of memory in the memory system that comprises the plurality of multiple-level cells, wherein the message comprises a first indication of a potential capacity of the plurality of multiple-level cells and a second indication of a configured capacity of the plurality of multiple-level cells.

30. The non-transitory, computer-readable medium of claim 29, wherein the instructions are further executable by the one or more processors, individually or collectively, to cause the host system to:
determine a capacity adjustment factor for the section of memory, wherein, to determine the capacity adjustment factor, the instructions are further executable by the one or more processors, individually or collectively, to cause the host system to:
read a first field of the message that comprises the first indication of the potential capacity of the plurality of multiple-level cells, wherein a first value of the potential capacity of the plurality of multiple-level cells is obtained based at least in part on reading the first field of the message;
read a second field of the message that comprises the second indication of the configured capacity of the plurality of multiple-level cells, wherein a second value of the configured capacity of the plurality of multiple-level cells is obtained based at least in part on reading the second field of the message; and
divide, based at least in part on obtaining the first value and the second value, the first value by the second value to obtain the capacity adjustment factor.
